(19) United States
(12) Patent Application Publication
(10) Pub. No.: US 2014/0048201 A1
(43) Pub. Date: Feb. 20, 2014

(54) BONDING OF THIN LAMINA

(71) Applicant: GTAT Corporation, Nashua, NH (US)

(72) Inventors: Venkateswaran Subbaraman, Santa Clara, CA (US); Orion Leland, Fremont, CA (US); Steve Peterson, Milpitas, CA (US); Steve Babayan, Los Altos, CA (US); Keenan K. Leon Guerrero, Boise, ID (US); Steve Zuniga, Soquel, CA (US); Robert Tolles, San Jose, CA (US)

(73) Assignee: GTAT Corporation, Nashua, NH (US)

(21) Appl. No.: 13/964,056

(22) Filed: Aug. 10, 2013

Related U.S. Application Data
(60) Provisional application No. 61/683,313, filed on Aug. 15, 2012.

(51) Int. Cl. B32B 37/10

(52) U.S. Cl. CPC B32B 37/10
USPC 156/249; 156/247; 156/583.1

(57) ABSTRACT

Methods and apparatus are provided for bonding a thin lamina to a carrier. In some embodiments, a first side of the lamina is separably contacted to a support plate. A first carrier having a first side with a layer of adhesive material is contacted to the second side of the thin lamina. The lamina is fixed to the first carrier, where the fixing includes a first application of heat and pressure to a portion of the lamina and the first carrier. The support plate is removed, and a second application of heat and pressure are applied to the lamina and the first carrier. The second application of heat and pressure promotes an adhesive bond between the lamina and the first carrier. The second application of pressure comprises moving the lamina, the first carrier and a cover sheet between a pair of rollers.

### RELATED APPLICATIONS

This application claims priority to U.S. Provisional Patent Application No. 61/683,313 filed on Aug. 15, 2012, entitled “Bonding of Thin Lamina”, and hereby incorporated by reference for all purposes.

### BACKGROUND

Sivaram et al., U.S. patent application Ser. No. 12/026,530, “Method to Form a Photovoltaic Cell Comprising a Thin Lamina,” filed Feb. 5, 2008, and issued as U.S. Pat. No. 8,481,845, owned by the assignee of the present disclosure and hereby incorporated by reference, describes fabrication of a photovoltaic cell comprising a thin semiconductor lamina formed of non-deposited semiconductor material. Using the methods of Sivaram et al., and others, photovoltaic cells and other electronic devices, rather than being formed from sliced wafers, are formed of thin semiconductor laminae without wasting silicon through kerf loss or by fabrication of an unnecessarily thick cell, thus reducing cost. The same donor wafer can be reused to form multiple laminae, further reducing cost, and may be resold after exfoliation of multiple laminae for some other use. Methods are needed for handling thin lamina in order to process them into electronic devices.

### SUMMARY

Methods and apparatus are provided for bonding a thin lamina to a carrier, the methods may comprise providing a thin lamina wherein the lamina has a first side and a second side and wherein the first side of the lamina is separably contacted to a support plate; providing a first carrier having a first side and a second side and wherein the first side comprises a layer of adhesive material; contacting the second side of the thin lamina to the first side of the first carrier; fixing the lamina to the first carrier wherein the fixing comprises applying a first application of heat and a first application of pressure to a portion of the lamina and the first carrier; removing the support plate; applying a second application of heat and a second application of pressure to the lamina and the first carrier wherein the second application of heat and the second application pressure promotes an adhesive bond between the lamina and the first carrier and wherein the second application of pressure comprises moving the lamina, the first carrier and the cover sheet between a pair of rollers.

### BRIEF DESCRIPTION OF DRAWINGS

FIG. 1 is a simplified flow chart of an exemplary method.

FIGS. 2A and 2B show two views of an embodiment of a device.

FIGS. 3A through 3D show a simplified schematic of exemplary methods and devices.

### DETAILED DESCRIPTION OF THE EMBODIMENTS

Methods and apparatus are provided for bonding a thin lamina to a carrier using heat and pressure, the pressure applied by a least one pair of rollers. The methods may bond the carrier to any side of a thin lamina in a manner that minimizes trapped air between the carrier and the lamina.

Sivaram et al., U.S. Pat. No. 8,481,845, and Kell et al., U.S. Pat. No. 8,268,645, “Method and Apparatus for Forming a Thin Lamina”, both of which are owned by the assignee of the present disclosure and are hereby incorporated by reference, describe the fabrication of a photovoltaic cell comprising a thin semiconductor lamina formed of non-deposited semiconductor material. Using the methods of Sivaram et al. and others, photovoltaic cells and other electronic devices, rather than being formed from sliced wafers, are formed of thin semiconductor laminae without wasting silicon through kerf loss or by fabrication of an unnecessarily thick cell, thus reducing cost. The same donor wafer may be reused to form multiple laminae, further reducing cost, and may be resold after exfoliation of multiple laminae for some other use. In some embodiments free standing semiconductor lamina obtained by methods of Sivaram et al., or Kell et al., may be bonded to a carrier in order to be safely handled and processed into a variety of devices in addition to photovoltaic devices, such as CMOS devices, substrates for 3-D semiconductor packages, LED devices, high electron mobility devices, and the like. In some embodiments a permanent or temporary carrier may be bonded to a free standing lamina after it is cleaved from the donor wafer as described in Murali, et al., U.S. Pat. No. 8,173,452, “A Method to Form a Device by Constructing a Support Element on a Thin Semiconductor Lamina”, owned by the assignee of the present disclosure and hereby incorporated by reference.

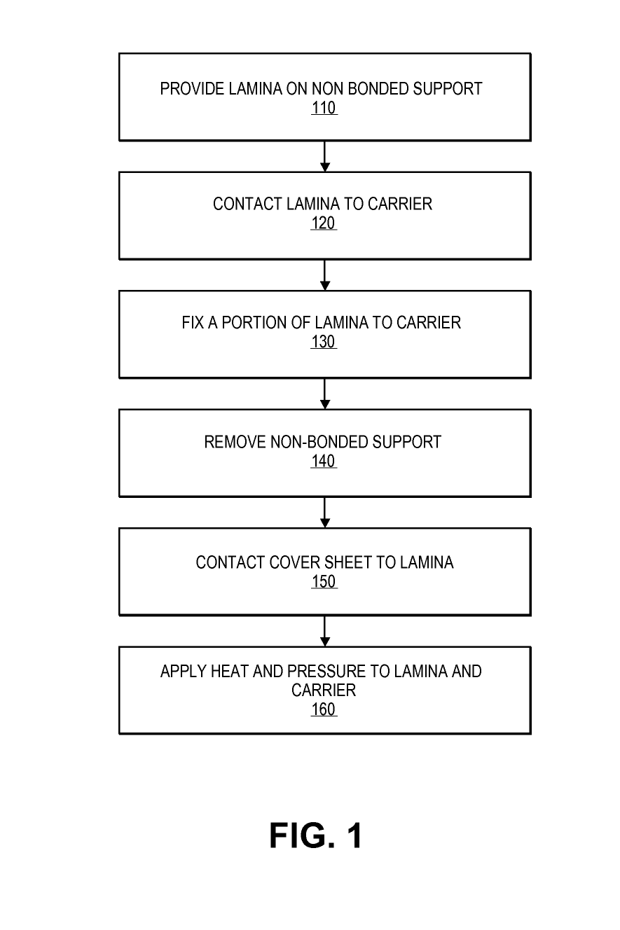

An embodiment of the method is shown in FIG. 1. A lamina is provided on a non bonded support in step 110. The lamina may be between 2 and 50 μm, such as between 5 and 25 μm or between 10 and 20 μm. The lamina may be comprised of any material, such as monocrystalline silicon, germanium, gallium arsenide, silicon carbide or any combination thereof. In some embodiments the method may comprise providing a lamina wherein the first side of the lamina may be separably contacted to a rigid support plate (e.g., porous graphite susceptor, silicon carbide, or plastic). The contact between the support plate and the lamina may be free of any chemical or electrostatic force. In some embodiments the support plate is a porous susceptor and the force between the susceptor and the lamina is a vacuum force. The second side of the lamina is contacted to a carrier in step 120. In some embodiments the carrier may comprise a layer of adhesive material on a first side that is heat activated and/or heat decomposable; for example, Brainard, et al., U.S. patent application Ser. No. 13/456,134, “A Method of Forming a Permanently Supported Lamina”, filed Apr. 25, 2012, owned by the assignee of the present disclosure and hereby incorporated by reference. The carrier may be a temporary or permanent carrier. In some embodiments the carrier may comprise silicon carbide, glass, silicon, plastic, fluoropolymers, metal or any combination thereof. The method may comprise fixing the lamina to the first side of the first carrier wherein the fixing comprises applying a first application of heat and a first application of pressure to a portion of the lamina and the first carrier (step 130). The first application of heat may be between, for example, 100-150° C., and the first application of pressure may be, for example, between 5 PSI-150 PSI. In some embodiments the portion of the lamina fixed to the carrier during the fixing step may be between 1 and 6% of the area of the lamina, such a band shaped region 1 and 15 mm wide (e.g., 3 and 10 mm wide) along an edge (e.g., chamfer or straight edge) on one side of the lamina. This may beneficially fix the lamina to the carrier in an aligned orientation. Once the lamina is fixed to the carrier at a point or region, the support plate may be removed from the lamina in step 140. A flexible contact or cover sheet may be optionally contacted to the second surface of the lamina, beneficially protecting the lamina, creating a stack comprising the carrier, lamina and cover sheet (step 150). The stack may be between 500 and 1500 microns thick, such as between 600 and 1000 microns thick. The lamina may be bonded to the carrier by the application of heat and pressure in step 160. The heat and pressure may be adjusted in order to minimize the formation of air bubbles between the lamina and the carrier.

In some embodiments the method may comprise fixing the lamina to the carrier; removing the support plate; applying a cover sheet to the first side of the lamina; applying a second application of heat and a second application of pressure to the lamina and the first carrier wherein the second application of heat and the second application pressure promotes an adhesive bond between the lamina and the first carrier and wherein the second application of pressure comprises moving the lamina, the first carrier and the cover sheet between a pair of rollers. The method advantageously provides for the bonding of a carrier material to any side of a thin lamina after it has been exfoliated or separated from a donor wafer or other thicker source material.

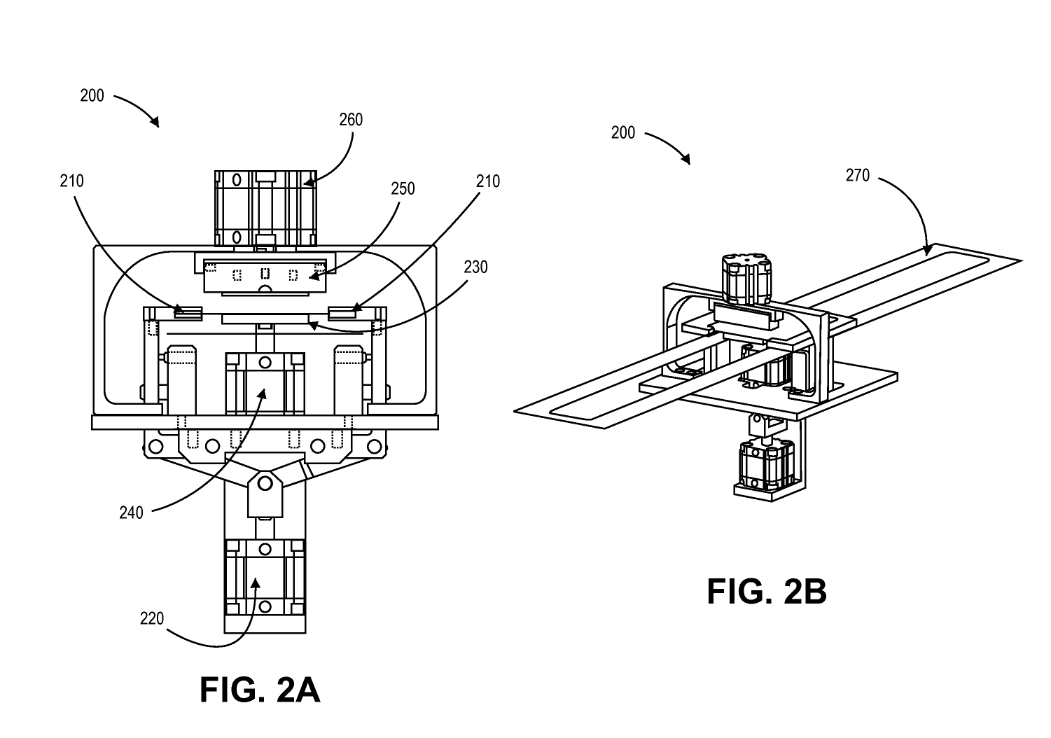

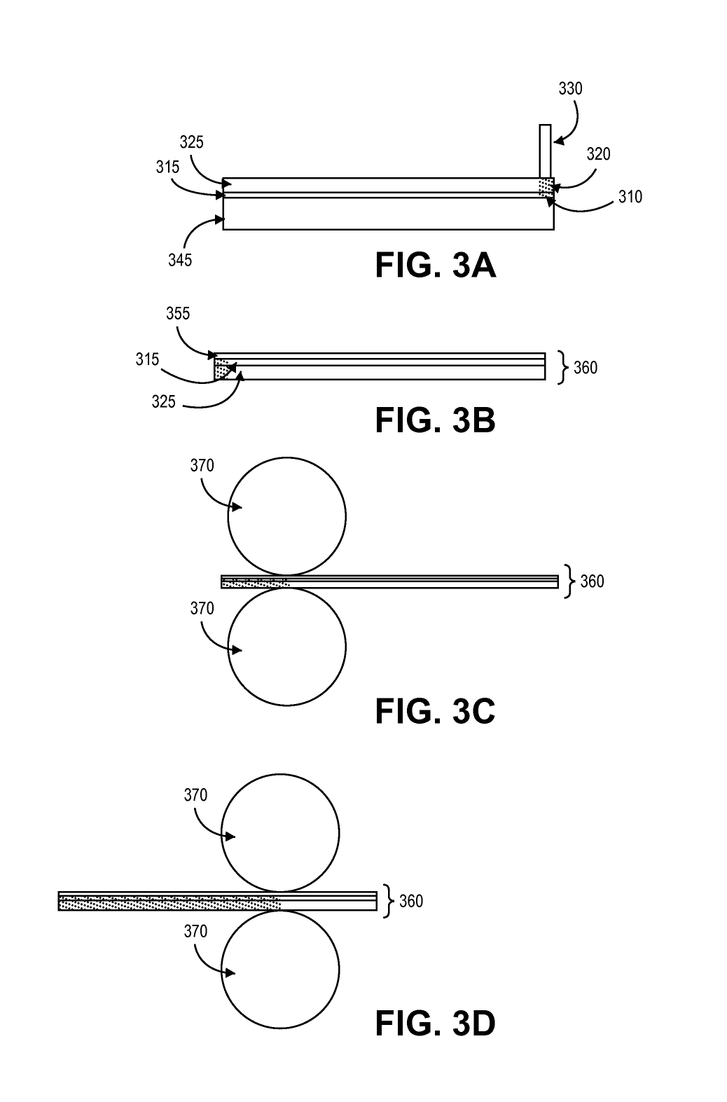

The methods of the present disclosure may be achieved by various apparatuses such as those illustrated in FIGS. 2 and 3. FIGS. 2A and 2B show two views of an embodiment of a device 200 used for fixing the edge of the lamina to the carrier. The device 200 may include a pair of jaws 210 actuated by a first pneumatic cylinder 220 to hold and chuck a carrier in place as well as enable the alignment of the lamina to the carrier. The vacuum chuck 230 may be attached at the top of a second pneumatic cylinder 240. A heated tacking bar 250 may be actuated from above on an edge of the lamina/carrier assembly by a third pneumatic cylinder 260 for the carrier. Once the carrier is chucked and aligned to the lamina, the heated tacking bar 250 may be lowered and pressed against the lamina/carrier assembly. The heat melts the adhesive applied on to the surface of the carrier and tacks the lamina to the carrier. A conveyor belt 270 may be used to process multiple stacks.

FIGS. 3A through 3D show a schematic illustration of an embodiment of the method and devices. In FIG. 3A a portion (shaded) 310 of the lamina 315 is fixed (e.g., bonded, or tacked) to a portion (shaded) 320 of carrier 325 by the application of pressure (and optionally heat) from a tacking device 330. The tacking device 330 may be any device for applying pressure and optionally heat to a lamina, such as the device shown in FIGS. 2A and 2B. The lamina may be supported by a susceptor 345 that may be removed following the fixing of the lamina to the carrier. A stack 360 comprising the carrier 325, lamina 315 and cover sheet 355 may now be assembled and is shown in FIG. 3B with the fixed portion indicated by the shaded area. In some embodiments, bonding the lamina to a carrier may comprise heating the stack to a temperature that activates the adhesive such as between 100 and 200° C. or between 140 and 160° C. as shown in FIG. 3C. The heat may be applied by any means, such as by heating elements (not shown) near the rollers or heated rollers 370 as shown in FIG. 3C. The rollers 370 may be rotatable pressure laminating rollers having peripheral surfaces positioned and dimensioned with a nip width to engage the lamina between the carrier and a cover sheet. The laminating rollers may be configured to be capable of applying a band of heat and pressure between 3 and 6 mm wide to the lamina between the carrier and the cover sheet, where the nip width is between 500 and 1500 microns wide. The stack 360 may then be driven through one or more pairs of rollers 370 at a uniform rate (e.g., between 0.2 cm/sec to 2.0 cm/sec) applying sufficient nip pressure to bond the carrier to the lamina (e.g., between 5 and 150 PSI). (FIG. 3D). Driving the stack 360 between at least one pair of rollers 370 to apply pressure to the lamina and carrier in a uniform fashion beneficially reduces the occurrence of air trapped between the lamina and the carrier. In some embodiments two or more pairs of rollers may be utilized in this process and may be separately heated at varying temperatures in order to create a thermal gradient as the stack passes through the sets of rollers. The coversheet 355 may be removed from the bonded lamina and optionally reused. Once the bonded lamina is fixed to a carrier, it may be processed as needed to make any electronic device.

Conventional flat press/vacuum systems used to bond thicker solar cells to carriers may provide less control of temperature and pressure as the carrier and lamina are bonded, resulting in the introduction of air bubbles between the stacks that may crack or otherwise damage the thinner lamina utilized in the present disclosure. Thus, the present methods provide a more efficient way to bond a thin lamina to a carrier with reduced damage or stress on the lamina. Temperature, pressure and rate of rolling may be adjusted to minimize air trapped between the lamina and the carrier. The lamina bonded to the carrier by the methods herein may contain fewer than 2 bubbles >1 mm in diameter per 200 cm² lamina, such as 0 bubbles >1 mm in diameter per 200 cm² lamina. In some embodiments the lamina bonded to the carrier by the present methods may contain fewer than 2 bubbles >0.6 mm in diameter per 200 cm² lamina, such as 0 bubbles >0.6 mm in diameter per 200 cm² lamina. In some embodiments the lamina bonded to the carrier by the present methods may contain fewer than 2 bubbles >0.3 mm in diameter per 200 mm² lamina, such as 0 bubbles >0.3 mm in diameter per 200 mm² lamina. In some embodiments the carrier first bonded to the lamina by the present methods may be a temporary carrier. The lamina may then be processed by any means, such as the application of additional layers or devices. The temporary carrier may then be removed and a second (permanent) carrier may be applied by the methods described above to the same side as the first carrier, or optionally, the opposite side.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

1. A method of bonding a thin lamina to a carrier, the method comprising the steps of:
providing a thin lamina, wherein the lamina has a first side and a second side and wherein the first side of the lamina is separably contacted to a support plate;
providing a first carrier having a first side and a second side and wherein the first side of the carrier comprises a layer of adhesive material;
contacting the second side of the thin lamina to the first side of the first carrier;
fixing the lamina to the first carrier, wherein the fixing comprises applying a first application of heat and a first application of pressure to a portion of the lamina and the first carrier;
removing the support plate; and
applying a second application of heat and a second application of pressure to the lamina and the first carrier, wherein the second application of heat and the second application pressure promotes an adhesive bond between the lamina and the first carrier, and wherein the second application of pressure comprises moving the lamina and the first carrier between a pair of rollers.

2. The method of claim 1 wherein the adhesive material is decomposable glue.

3. The method of claim 1 further comprising applying a cover sheet to the first side of the lamina prior to applying the second application of heat and the second application of pressure to the lamina and the first carrier.

4. The method of claim 1 wherein the first application of heat is between 100 and 150° C.

5. The method of claim 1 wherein the second application of heat is between 100 and 200° C.

6. The method of claim 1 wherein the first application of pressure is between 5 PSI-150 PSI.

7. The method of claim 1 wherein the second application of pressure is between 5 PSI-150 PSI.

8. The method of claim 3 wherein the cover sheet is reusable.

9. The method of claim 1 wherein the first carrier is selected from the group consisting of silicon, glass, metal, and plastic.

10. The method of claim 1 wherein the lamina is selected from the group consisting of silicon, silicon carbide, gallium nitride, germanium and gallium arsenide.

11. The method of claim 1 further comprising:
applying additional layers of material to the first side of the lamina;
removing the first carrier from the second side of the lamina; and
contacting a second carrier to the first side of the lamina.

12. The method of claim 1 wherein the support plate is selected from the group consisting of silicon carbide, porous graphite and plastic.

13. The method of claim 1 wherein the support plate is reusable.

14. The method of claim 1 wherein the support plate is porous.

15. The method of claim 1 wherein separable contact between the support plate and the lamina comprises a vacuum force.

16. The method of claim 1 wherein the first application of heat and pressure comprises a band between 1 and 15 mm wide.

17. The method of claim 1 wherein the pair of rollers are rolling at a rate of between 0.2 cm/sec to 2.0 cm/sec.

18. A laminating machine for applying a carrier to a lamina, wherein the carrier has a layer of heat-activatable adhesive thereon, the adhesive having an activating temperature, the machine comprising:
a pair of rotatable pressure laminating rollers having peripheral surfaces positioned and dimensioned with a nip width to engage the lamina between the carrier and a cover sheet, the laminating rollers including a first heating element capable of heating the laminating rollers to at least the activating temperature;
wherein the laminating rollers are capable of applying a band of heat and pressure between 3 and 6 mm wide to the lamina between the carrier and the cover sheet, wherein the nip width is between 500 and 1500 microns wide.
